(19) United States
(12) Patent Application Publication
(10) Pub. No.: US 2026/0304563 A1
(43) Pub. Date: Oct. 1, 2026

(54) HEATING DEVICE AND METHOD FOR PRODUCING A HEATING DEVICE

(71) Applicant: M&R KREATIV GMBH, Saarbrücken (DE)

(72) Inventors: Michael Hugo ZIMMER, Saarbrücken (DE); David ZIMMER, Saarbrücken (DE)

(21) Appl. No.: 18/880,146

(22) PCT Filed: Jul. 13, 2023
(86) PCT No.: PCT/EP2023/069523

§ 371 Date: Dec. 30, 2024

(30) Foreign Application Priority Data
Jul. 14, 2022 (LU) LU502512
Feb. 15, 2023 (LU) LU503493

(51) Int. Cl. H05B 3/20; C09D 133/12; H05B 3/06

(52) U.S. Cl. CPC H05B 3/20; C09D 133/12; H05B 3/06; H05B 2203/013; H05B 2203/017

(57) ABSTRACT

A method for producing a heating device, in which material layers are applied one after another in layers, forming a heating unit. The material layers are applied on top of one another by a printing method, with one of the material layers including an electrically conductive material to form a heating resistor and another of the material layers including an electrically insulating material.

The present invention relates to a process for producing a heating means, in particular for heating buildings, to a means for performing the process and to a heating means.

Heating means, in particular for heating buildings, are known from their use. To form an underfloor heating means, heating conduits or heating resistors are arranged under tiles.

It is an object of the present invention to provide a simple and cost-effective process for producing heating means.

According to the invention this object is achieved when material layers forming a heating unit are gradually applied layerwise on top of one another using a printing process, wherein one of the material layers comprises an electrically conductive material for forming a heating resistor and a further of the material layers comprises an electrically insulating material.

Advantageously at least one of the material layers comprises a material for joining the heating unit to a workpiece or is formed by the material, wherein the joining material is preferably formed by a glass paste. The glass paste preferably comprises silicon oxide, silicon nitride, aluminum and/or titanium.

The material layer for forming the heating resistor is preferably arranged between the material layer comprising the electrically insulating material and the material layer for joining the heating unit.

In one embodiment of the invention the material layer comprising the electrically insulating material is arranged, especially applied, on the material layer for forming the heating resistor in the form of a coating, a lacquer, a film and/or a glaze. The material layer comprising the electrically insulating material may be designed such that it comprises the same structure, color and/or the same material as the workpiece.

In one embodiment of the invention a further of the material layers is formed by a thermally conductive, electrically insulating and heat resistant material, especially a lacquer, which preferably comprises methyl methacrylate (MMA). Material may preferably be removed and replaced by the material layer at least in the surface region of the workpiece provided for arranging the heating unit.

In one embodiment of the invention the material layers are applied screen printing process, a photoelectric printing process, preferably using a laser printer, an LED printer and/or an LCD/LCS printer and/or using an inkjet printing process, preferably using an inkjet printer.

The electrically conductive material for forming the heating resistor advantageously comprises a metal, preferably silver, copper, heating conductor alloys and/or silicon carbide, molybdenum silicide and/or graphite, wherein the material layer for forming the heating resistor is preferably formed by a paste containing the electrically conductive material. The paste preferably contains acrylic resin.

The material layers, in particular the material layer comprising the electrically conductive material for forming the heating resistor, are preferably applied in pasty form using the printing process. A paste containing the electrically conductive material preferably contains a filler and/or reinforcer having a high electrical resistance, for example glass or ceramic particles, preferably silicon oxide particles. The specific resistance of the heating resistor may be adjusted by means of the filler and/or reinforcer.

In one embodiment of the invention the electrically conductive material in the material layer for forming the heating resistor is arranged only in sections, preferably in the form of lines, preferably to form a wound, serpentine and/or spiral shape.

It is advantageous when not only the electrically conductive material but also an electrically insulating material is arranged in the material layer for forming the heating resistor. In one embodiment of the invention the material layers for forming the heating unit are formed on a layer carrier which is preferably in the form of a film or a paper, especially silicone paper, wax paper or polytetrafluoroethylene-coated paper. Since the film and the paper are flexible materials and can be rolled up, especially when in the form of webs, they are particularly suitable for the process. It is advantageous when a first material layer is printed on the layer carrier and the further material layers are subsequently arranged, especially printed, layerwise on top of one another and/or successively.

The layer carrier is advantageously designed such that the material layers adhere to it, especially also during motion of the layer carrier, but are completely detachable from it during building of the workpiece. It has proven particularly advantageous for handling to use a flexible layer carrier.

The layer carrier is preferably in the form of a web and optionally designed for arrangement on a roll. If two or more of the material layers are arranged on the layer carrier one embodiment of the invention provides for rolling up the layer carrier together with the material layers arranged thereupon, preferably onto the roll, to allow simple storage and/or transportation thereof.

To transfer the material layers onto the workpiece the layer carrier, advantageously together with the material layers, is unrolled, especially from the roll, and moved to a transfer means which can be used to arrange the heating unit on the workpiece.

In one embodiment of the invention the transfer means comprises a means for heating a joining region between the heating unit and the workpiece, a means for pressing the heating unit onto the workpiece and/or a means for treating the surface of the workpiece.

The treatment means is advantageously designed for treating, in particular for cleaning and/or roughening, at least the surface region of the workpiece provided for arranging the heating unit, and/or for removing material of the workpiece in the surface region. The material may preferably be removed chemically, in particular by chemical decomposition, thermally, in particular by melting, and/or mechanically, in particular by grinding and/or machining. It goes without saying that the treatment means may also be provided separately from the transfer means.

It is preferable when a plurality of heating units are, especially uninterruptedly, formed on the layer carrier, wherein individual heating units and/or groups of heating units may be separated from the further heating units formed on the layer carrier by a separating means, and may especially be cut and/or torn off. This allows uninterrupted printing of the layer carrier. An appropriate number of heating units may be provided according to the size and/or shape of the surface of the workpiece provided for attachment of the heating unit. It is advantageous when the transfer means comprises the separating means.

The process step of printing the layer carrier, which is substantially faster than the transfer of the material layers from the layer carrier to the workpiece, and the process step of layer transfer may be separated from one another. This allows for better handling of the production of the layers and of the workpiece.

This further allows for the possibility of providing the electrophotographic printing means at a different site from the transfer means.

A single printing means may optionally supply a plurality of transfer means, optionally provided at different sites, with the layer carriers provided with the layers.

The layer carrier and the layers arranged thereupon form an intermediate in the process according to the invention when the layer carrier is fully arranged on the roll and the roll is adapted for use in a means for transferring the layer from the layer carrier to the workpiece.

The layer carrier could also be provided as a plurality of individual sheets which could preferably be stacked in the printed state. To transfer the respective layer or layers to the workpiece the individual sheets could be transported to the transfer means from a stack of the individual sheets, preferably using a means for dispensing individual sheets.

In a further embodiment of the invention the layer carrier is configured as an endless belt, i.e. as a closed ring, and during transfer the layer is gradually always reapplied thereto and detached again therefrom. It goes without saying that the endless belt is circulatorily moved past the layer forming means to be provided with a layer and, downstream thereof in the advancement direction of the endless belt, moved past the workpiece in order that the layer may be transferred to the workpiece.

The material layers are advantageously arranged on a workpiece, optionally by detachment from the layer carrier, wherein the material layer comprising the electrically insulating material is preferably formed on the side of the heating unit facing away from the workpiece.

In a particularly preferred embodiment of the invention the material layers are applied directly from the roll onto the workpiece.

The material layers are advantageously insolubly joined to the workpiece, preferably by heating, preferably to form an atomic-level and/or interlocking join.

The material layers are advantageously heated to 600° C. to 1100° C. At least individual components of the material layers, especially the glass constituents, are liquefied. This results in an atomic-level join between the material layers and in an atomic-level join with the surface of the workpiece. The heating resistor is formed along the aforementioned sections in which the electrically conductive material is arranged.

In one embodiment of the invention the layer carrier is completely rolled up onto a roll after printing with the material layers.

In one embodiment of the invention the printing means comprises a control means for controlling the printing means and/or a holder for the roll on which the layer carrier is arranged and/or printing drums adapted for printing different materials. It is preferable when the control means comprises a computer which is adapted for generating information which may be used to determine the shapes of the material layers and the materials to be used for formation thereof using digital drawings or models, in particular CAD files, which describe the shape of the workpiece to be printed and/or covered, in particular the region of the workpiece in which the material layers are to be applied. Furthermore, the computer may manually provide further information.

It would be conceivable for the material layers to preferably have a combined thickness of at most 100 μm, preferably at most 60 μm.

In the region where the material layers are applied the workpiece may have an uneven shape, in particular at least a curvature, an edge and/or a corner.

In the region where the material layers are applied a surface of the workpiece is preferably formed of a metal, preferably steel, an enamel, stone, wood, a ceramic, a building material, especially concrete, and/or of a plastic.

In a preferred embodiment the workpiece is a piece of ceramicware, especially a, preferably ceramic, tile, a piece of sanitaryware, preferably a sink, a bidet, a WC bowl, a urinal, a bathtub, a shower tray or a fitting, for example a mixer fitting.

In a particularly preferred embodiment of the invention the heating unit, especially after joining to the workpiece, has a thickness of at most 150 μm, preferably at most 50 μm, particularly preferably at most 30 μm.

The workpiece provided with the heating unit preferably forms the heating means.

In one embodiment of the invention the heating means comprises a contacting means which is provided for electrical connection of the heating means and/or the heating unit, especially the electrically conductive material, to an external electricity supply. The contacting means may be configured as a connector, a fed-through cable, a fed-through wire and/or a coil for inductive transfer of electrical energy.

It is preferable when the heating unit, especially the contacting means, comprises a temperature control means, preferably a thermostat, particularly preferably a temperature switch and/or a temperature controller, by means of which the supply of electrical current may be regulated. The heating means, especially the temperature control means, may further comprise a temperature sensor designed for monitoring the temperature of the heating means, in particular of the workpiece and/or of the heating unit.

To adapt the temperature of the heating means the contacting means may comprise a controllable power supply, preferably a mains power supply, particularly preferably a switched-mode power supply.

For electrical connection of the heating unit with the contacting means and/or with further heating units the heating unit preferably comprises at least one, especially bipolar, connection, in particular a plug connection, a solder joint, a ring terminal, a screw connection and/or an adhesive joint. The connection is advantageously formed by the printing means, in particular as part of the material layer for forming the heating resistor.

In one embodiment of the invention a plurality of heating units are electrically connected to one another or may be electrically connected to one another through, especially bipolar, connection means.

An end piece is preferably provided to close the electrical circuit of one or more heating units. The end piece is provided for bridging, especially shorting, one or more open connections. The end piece preferably comprises the temperature control means and/or the temperature sensor.

The invention will now be more particularly elucidated with reference to exemplary embodiments and the accompanying drawings which refer to these exemplary embodiments. In the figures:

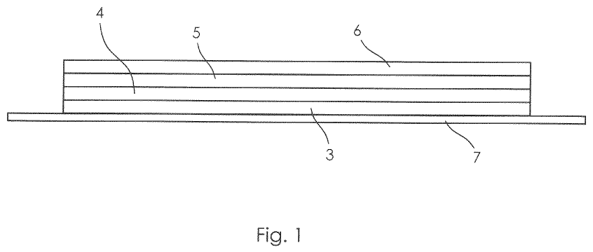

FIG. 1 shows an inventive heating unit applied to a layer carrier,

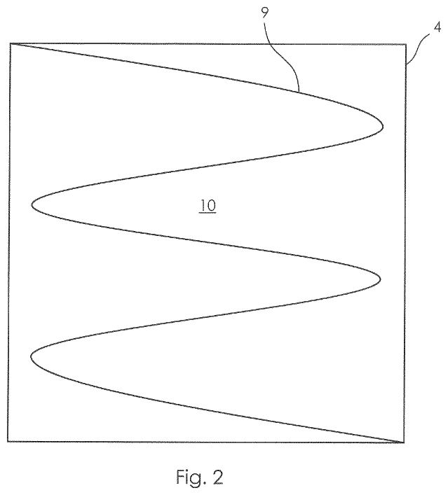

FIG. 2 shows a detail view of a material layer for forming a heating resistor,

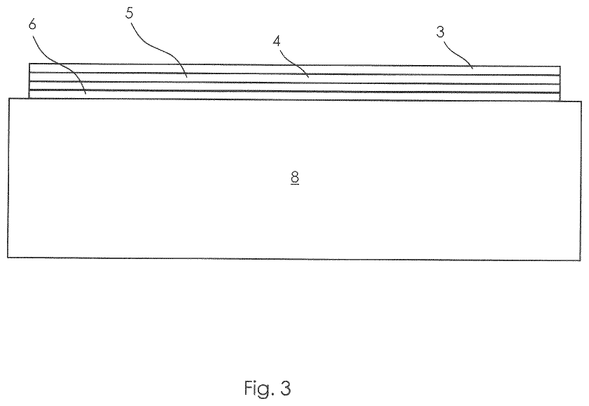

FIG. 3 shows an inventive heating unit applied to a workpiece,

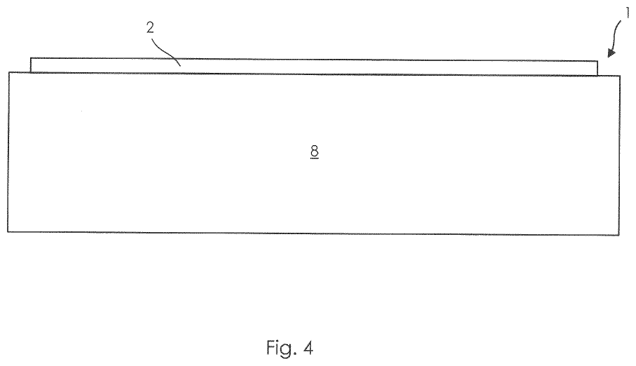

FIG. 4 shows an inventive heating means,

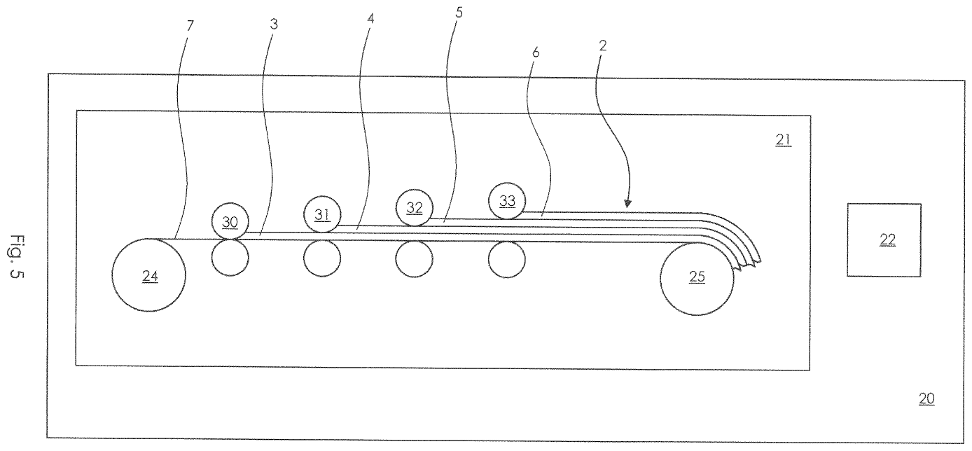

FIG. 5 shows an exemplary embodiment of a printing means for applying the inventive heating unit to a layer carrier,

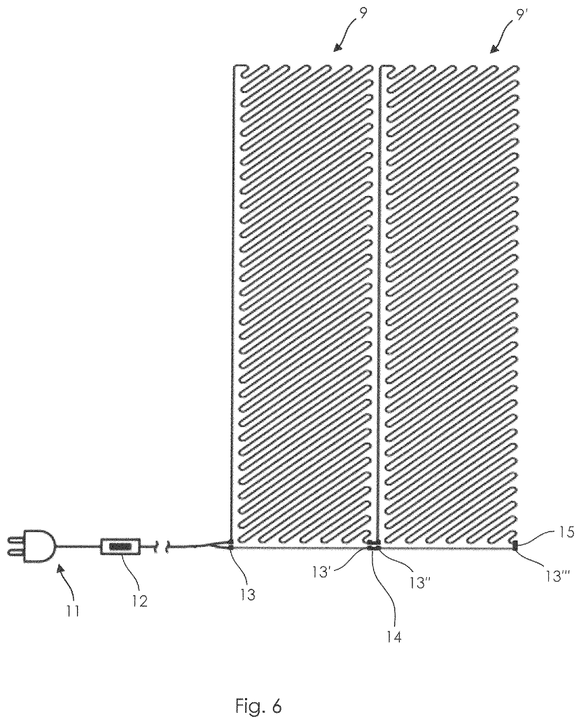

FIG. 6 shows a detail view of an electrical connection of an inventive heating unit and

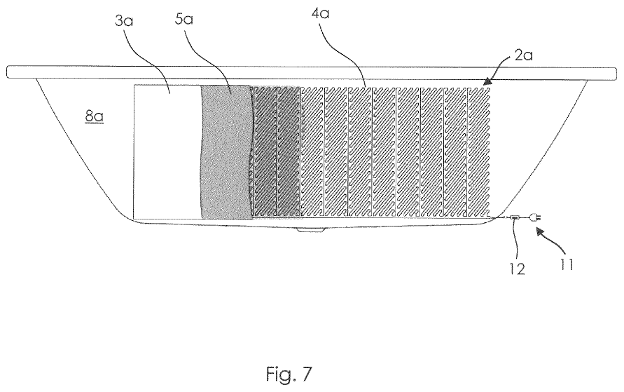

FIG. 7 shows an exemplary embodiment of an inventive heating unit attached to a bathtub.

In a first exemplary embodiment an inventive heating unit 2 is formed by screen printing.

To this end, as shown in FIGS. 1 and 5, a material layer 3 in the form of a lacquer comprising an electrically insulating material is first printed onto a layer carrier 7 formed by polytetrafluoroethylene-coated paper. The layer carrier 7 could be formed by a film or paper, in particular silicone paper or wax paper, and/or the material layer 3 provided in the form of a coating and/or a glaze.

Another material layer 4, comprising electrically conductive material 9 for forming a heating resistor and an electrically insulating filler and/or reinforcer 10 which surrounds and electrically insulates the electrically conductive material in the material layer 4, is printed onto the material layer 3. In the exemplary embodiment according to FIG. 2 the filler and/or reinforcer 10 comprises glass particles, ceramic particles and/or silicon oxide particles. In the pasty material layer 4 the electrically conductive material is printed in the form of at least one preferably wound, serpentine and/or spiral-shaped line or optionally plurality of lines (see reference 9 in FIG. 2). The electrically conductive material comprises for example metal, preferably copper, silver and/or heating conductor alloys, silicon carbide, molybdenum silicide and/or graphite.

A further material layer 5 which effects a joining of the heating unit 2 to a workpiece 8 is printed onto the material layer 4. The material layer 5 is formed by a glass paste which comprises for example silicon oxide, silicon nitride, aluminum and/or titanium.

An additional material layer 6 which comprises or is formed by a lacquer may optionally be applied, especially printed, before arrangement of the material layer 3 or the layer carrier 7 or after arrangement of the material layer 5. The material layers 3, 4, 5 may be provisionally joined to one another by means of the lacquer.

Alternatively to the screen printing process the material layers 3, 4, 5, 6 may also be formed using a laser printer, an LED printer and/or an LCD/LCS printer and/or using an inkjet printing process, preferably using an inkjet printer.

After printing with the material layers 3, 4, 5, 6 the layer carrier 7 including the material layers 3, 4, 5, 6 is rolled up onto a roll 25. The roll 25 now provided with the printed layer carrier 7 may be intermediately stored and transported.

To provide the workpiece 8 with the material layers 3, 4, 5, 6, the layer carrier 7 including the material layers 3, 4, 5, 6 is rolled up and the material layers 3, 4, 5, 6 applied to the workpiece 8 using a roller and/or a squeegee (cf. FIG. 3). The workpiece 8 and/or the material layers 3, 4, 5, 6 may optionally be heated to achieve an optionally provisional join between the material layers 3, 4, 5, 6 and the workpiece 8.

The workpiece 8 and the material layers 3, 4, 5, 6 are subsequently heated to 600° C. to 1100° C. at least in the region where the material layers 3, 4, 5, 6 are arranged such that the material layers 3, 4, 5, 6 are insolubly joined to one another and to the workpiece 8. The heating temperature is selected according to the employed materials such that at least the material layers 4, 5 achieve a sufficiently low viscosity or become sufficiently liquid for the material layers 3, 4, 5 to become joined to one another.

The heating temperature may be selected such that the lacquer of the material layer 6 decomposes, preferably completely.

The workpiece 8 together with the heating unit 2 forms a one-piece heating means 1 (cf. FIG. 4). In the exemplary embodiment the workpiece 8 is a tile. It goes without saying that the workpiece 8 may also be a piece of ceramicware, especially a ceramic tile, a piece of sanitaryware, preferably a sink, a bidet, a WC bowl, a urinal, a bathtub, a shower tray or a fitting, for example a mixer fitting. The surface of the workpiece could further be formed of a metal, preferably steel, and enamel, stone, wood, a construction material, especially concrete, and/or of a plastic in the region where the material layers are applied.

The material layers 3, 4, 5, 6 may alternatively be applied to the layer carrier using a xerographic printing means 21. An inventive apparatus 20 shown in FIG. 5 comprises a xerographic printing means 21 which is adapted for printing a layer carrier 7 formed by a paper web with material layers 3, 4, 5, 6. Said means further comprises a control means 22 for controlling the printing means 21.

The printing means 21 comprises a holder for a roll 24 on which the layer carrier 7 is rolled up, as well as four printing drums 30, 31, 32, 33 provided with a light-sensitive coating which are adapted for printing different materials.

The control means 22 comprises a computer adapted for generating information which may be used to determine the shapes of the material layers 3, 4, 5, 6 and the materials to be used for formation thereof from CAD files which describe the shape of the workpiece 8 to be covered. The computer uses the information to generate print images with which the xerographic printing means 21 may be controlled.

Building of an inventive heating unit 2 is carried out as follows. Initially a CAD file containing information about the composition and arrangement of the material layers 3, 4, 5, 6 is loaded into the computer and the print images for the printing means 21 are generated therefrom.

The control means 22 uses the information to configure the printing means 21 and prompts the layer carrier 7 to be set into motion using stepper motors. From the roll 24 the layer carrier 7 is now passed through the printing means 21 and the material layers 3, 4, 5, 6 are formed using the printing drums 30, 31, 32, 33. The material layers 3, 4, 5, 6 may be formed uninterruptedly or in such a way that individual heating units and/or electrically connected groups of heating units are formed.

It will be appreciated that a printing means using the above-described screen printing process or other printing processes, especially photoelectric printing processes, preferably using a laser printer, an LED printer and/or an LCD/LCS printer, and/or inkjet printing processes, preferably using an inkjet printer, can also have the described features of the xerographic printing means 21.

After printing with the material layers 3, 4, 5, 6 the layer carrier 7, as described above for the screen printing process, is rolled up onto a roll 25 together with the material layers 3, 4, 5, 6. The roll 25 provided with the printed layer carrier 7 may be intermediately stored and transported.

The material layers 3, 4, 5, 6 can form the heating unit 2 as described above for the screen printing process and optionally be connected by heating to a workpiece (not shown here) to form the heating means.

The detail view of FIG. 6 shows the serpentine-printed electrically conductive material 9, 9′ provided for forming two heating units (not shown here). The electrically conductive material 9, 9′ comprises bipolar connections 13, 13′, 13″, 13′″ for connecting the heating unit to an electrical supply and for connecting further heating units. The connections 13, 13′, 13″, 13′″ were formed by the printing means (not shown here) but may also be adhesive joints, ring terminals, solder joints and/or a screw connection and/or a plug connection. A contacting means 11 supplies the heating units with current via a switched-mode power supply (not shown here) is connected to the first connection 13. The contacting means 11 further comprises a temperature control unit 12 comprising a temperature sensor (not shown here).

For electrical connection of the second electrically conductive material 9′ with the second connections 13′ of the first electrically conductive material 9 a bipolar connecting means 14 is provided.

The connecting means 14 is a constituent of the printed material layer 4, especially of the electrically conductive material 9, 9′, in such a way that all heating units uninterruptedly formed using the printing means and arranged on the same layer carrier are electrically connected to one another.

At the second connection 13′″ of the second electrically conductive material 9′ the layer carrier (not shown here) printed with the heating units is cut using a separating means (not shown here) of the transfer means (not shown here) in such a way that the connecting means are interrupted.

To close the electrical circuit an end piece 15 is provided at the second connection 13′″ of the second electrically conductive material 9′. Similarly to the connections 13, 13′, 13″, 13′″ and the connecting means 14 the end piece 15 is formed by the printing means, especially as a constituent of the printed material layer 4 for forming the heating resistor.

The connecting means 14 and/or end piece 15 could also be printed on another and/or the same layer carrier in the same way as the material layers and transferred onto the workpiece (not shown here) using the transfer means.

The connecting means 14 and/or the end piece 15 may be provided as an electrically conductive lacquer, adhesive and/or an electrically conductive paste or as a paint and/or a plug connection and/or a molten electrically conductive connection, especially a solder connection.

In the exemplary embodiment of FIG. 7 a conventional bathtub forms a workpiece 8a, wherein the bathtub is curved in the surface region provided for mounting a heating unit. Since the surface of the bathtub is already lacquered a heating unit 2a which comprises only the material layers 3a, 4a, 5a is provided for mounting to the workpiece 8a. To this end the heating unit 2a which is arranged on a layer carrier (not shown here) is pressed onto the bathtub surface using a transfer means (not shown here) in such a way that the material layer 5a for joining the heating unit 2a to the workpiece 8a adjoins the bathtub surface. As the connection material the material layer 5a comprises a glass paste by means of which the heating unit 2a is initially adhesively bonded to the workpiece 8a.

Alternatively the layer carrier comprising the material layers 3a, 4a, 5a may be pressed against the tub surface by hand, preferably using tools, in particular a roller and/or a squeegee. Subsequently or during the pressing the material layers 3a, 4a, 5a are detached from the layer carrier.

Finally, the material layers 3a, 4a, 5a are insolubly joined to the workpiece 8a.

If the lacquer of the bathtub is not heat-resistant and/or exhibits particularly poor thermal conductivity it may first be removed. The heating unit 2a then advantageously comprises an additional material layer which replaces the removed lacquer. To remove the lacquer the transfer means comprises a grinding means which is used to remove the lacquer. For the electrical supply of the heating unit 2a the contacting means 11 is provided in the form of a mains cable with a safety plug which further comprises the temperature control means 12.

1-24. (canceled)

25. A process for producing a heating device, comprising gradually applying material layers layerwise on top of one another using a printing process to form a heating unit, wherein one of the material layers comprises an electrically conductive material for forming a heating resistor and another of the material layers comprises an electrically insulating material.

26. The process according to claim 25, wherein a further of the material layers comprises a material for joining the heating unit to a workpiece or is formed by the material, wherein the joining material is preferably formed by a glass paste.

27. The process according to claim 26, wherein the joining material is a glass paste.

28. The process according to claim 26, including arranging the material layer for forming a heating resistor between the material layer comprising the electrically insulating material and the material layer for joining the heating unit.

29. The process according to claim 25, wherein a further of the material layers is formed by a lacquer which preferably comprises methyl methacrylate.

30. The process according to claim 29, wherein the lacquer comprises methyl methacrylate.

31. The process according to claim 25, including applying the material layers using a screen printing process, using a photoelectric printing process and/or using an inkjet printing process.

32. The process according to claim 26, wherein the electrically conductive material for forming the heating resistor comprises a metal, wherein the material layer for forming a heating resistor is a paste containing the electrically conductive material.

33. The process according to claim 32, wherein the metal is silver, copper, a heating conductor alloy and/or silicon carbide, molybdenum silicide and graphite.

34. The process according to claim 25, including applying the material layers in pasty form using the printing process.

35. The process according to claim 25, including arranging the electrically conductive material in the material layer for forming the heating resistor only in sections.

36. The process according to claim 35, including arranging the electrically conductive material in the material layer for forming the heating resistor in the form of lines.

37. The process according to claim 36, including arranging the electrically conductive material in the material layer for forming the heating resistor to form a wound shape.

38. The process according to claim 37, including arranging the electrically conductive material in the material layer for forming the heating resistor to form a serpentine and/or spiral shape.

39. The process according to claim 36, including arranging not only the electrically conductive material, arranged in the form of lines, but also an electrically insulating filler and/or reinforcer in the material layer for forming the heating resistor.

40. The process according to claim 25, including forming the material layers on a layer carrier.

41. The process according to claim 40, wherein the layer carrier is flexible.

42. The process according to claim 40, wherein the layer carrier is a film or a paper.

43. The process according to claim 42, wherein the layer carrier is silicone paper, wax paper or polytetrafluoroethylene-coated paper.

44. The process according to claim 40, including rolling up the layer carrier completely onto a roll after printing with the material layers.

45. The process according to claim 44, including arranging the material layers on a workpiece, optionally by detachment from the layer carrier, wherein the material layer comprising the electrically insulating material is formed on a side of the heating unit facing away from the workpiece.

46. The process according to claim 45, including applying the material layers directly from the roll onto the workpiece, wherein the material layer for joining the heating unit is arranged directly on the workpiece.

47. The process according to claim 45, including insolubly joining the material to the workpiece.

48. The process according to claim 47, including insolubly joining the material to the workpiece by heating.

49. The process according to claim 47, including insolubly joining the material to the workpiece to form an atomic-level and/or interlocking join.

50. The process according to claim 45, including applying the material layers to a region of the workpiece having an uneven shape.

51. The process according to claim 50, including applying the material layers to a curvature, an edge and/or a corner of the workpiece.

52. The process according to claim 45, wherein, in a region where the material layers are applied, a surface of the workpiece is formed of a metal, an enamel, a ceramic and/or of a plastic.

53. The process according to claim 52, wherein the surface of the workpiece is formed of steel.

54. The process according to claim 45, wherein the workpiece is a piece of ceramicware, a piece of sanitaryware or a fitting.

55. The process according to claim 54, wherein the workpiece is a tile.

56. The process according to claim 54, wherein the workpiece is a sink, a bidet, a WC bowl, a urinal, a bathtub or a shower tray.

57. A device for forming a heating unit for a heating device, comprising material layers, wherein one of the material layers is an electrically conductive material for forming a heating resistor and another of the material layers comprises an electrically insulating material, produced by the process according to claim 25.

58. The device for forming a heating unit according to claim 57, wherein a further of the material layers comprises a material for joining the heating unit to a workpiece or is formed by the material, wherein the joining material is formed by a glass paste.

59. The device for forming a heating unit according to claim 57, wherein the material layers are arranged on a layer carrier and the material layers are rolled up onto a roll together with the layer carrier.

60. A heating device, comprising a heating unit formed from material layers printed layerwise.

61. The heating device according to claim 59, wherein the heating device is arranged on a workpiece.

62. The heating device according to claim 61, wherein the workpiece is a piece of ceramicware, a piece of sanitaryware or a fitting.

63. The heating device according to claim 62, wherein the workpiece is a ceramic tile.

64. The heating device according to claim 62, wherein the workpiece is a a sink, a bidet, a WC bowl, a urinal, a bathtub or a shower tray.

65. The heating device according to claim 60, wherein one of the material layers is an electrically conductive material for forming a heating resistor and another of the material layers comprises an electrically insulating material.
